(19) United States
(12) Patent Application Publication
(10) Pub. No.: US 2006/0166731 A1
(43) Pub. Date: Jul. 27, 2006

(54) Linked jackpot controller topology

(76) Inventors: Osamu Yoshimi, Botany (AU); Koji Nakatsu, Botany (AU); Gerard Crosby, South Hurstville (AU); Jason Quayle, Pagewood (AU); Roy Issac, Fairfield Heights (AU)

Correspondence Address: KNOBBE MARTENS OLSON & BEAR LLP, 2040 MAIN STREET, FOURTEENTH FLOOR, IRVINE, CA, 92614, US

(21) Appl. No.: 11/322,021

(22) Filed: Dec. 29, 2005

Related U.S. Application Data
(63) Continuation-in-part of application No. 10/496,750, filed on Nov. 22, 2004.

(30) Foreign Application Priority Data
Nov. 26, 2001 (AU) PR9113
Feb. 23, 2005 (AU) 2005200808
Apr. 26, 2005 (AU) 2005902074
Jun. 16, 2005 (AU) 2005100497
Aug. 5, 2002 (WO) PCT/AU02/01050
Oct. 21, 2005 (WO) PCT/AU05/01649

(51) Int. Cl. A63F 13/00

(52) U.S. Cl. 463/20

(57) ABSTRACT

A system of interlinked gaming machines or consoles. A plurality of linked games with a secondary game associated with the plurality.

### RELATED APPLICATIONS

This application is a continuation-in-part of U.S. application Ser. No. 10/496,750, filed Nov. 22, 2004, which was the U.S. National Phase of PCT/AU02/01050 filed Aug. 5, 2002 and claims priority to Australian Patent Application No. PR9113 filed Nov. 26, 2001, and also claims priority to Australian Patent Application No. 2005200808, filed Feb. 23, 2005, Australian Patent Application No. 2005902074, filed Apr. 26, 2005, Australian Innovation Application 2005100497 filed Jun. 16, 2005 and PCT Application No. PCT/AU2005/001649 filed Oct. 21, 2005 which are hereby incorporated by reference in their entirety herein.

### BACKGROUND OF THE INVENTION

The present invention relates to a system of interlinked gaming machines or consoles of the type generally referred to as slot machines, fruit machines or poker machines, and in particular to the combination of a plurality of such machines or consoles with a jackpot management means.

Gaming or poker machines have become a major source of amusement and diversion in such places as clubs, hotels and casinos in many parts of the world.

Traditionally such machines were mechanical devices where a number of reels marked with a plurality of numbers or symbols could be made to spin randomly by the application of some mechanical input. If the subsequent patterns of numbers or symbols displayed on the reels, when these returned to a rest state, corresponded to predetermined patterns, the machine would provide a prize or payout. Generally such gaming machines have come to be regulated by government authorities as to their number and in the manner in which the machines must return a percentage of the money taken to the players.

The introduction of electronics, computers and video displays, has allowed a continual increase in the complexity and variations of gaming machines and games while maintaining the basic concept of the traditional machine.

Machines and games that offer novel and stimulating variations on the basic game theme and environment are eagerly sought by the gaming industry and there is consequently intense competition between machine manufacturers to innovate.

Nevertheless the repetitive playing of even modern gaming machines can lead to boredom of the players with a consequent under-utilization of machines and increase in player dissatisfaction. One perceived source of player boredom and alienation is the isolation of the player at his or her machine with little possibility of the stimulus of interaction with adjoining players.

Networked machine topologies have been published previously which broadly disclose the idea of a secondary game feature associated with a networked gaming machine environment. Such disclosures include the following:
1. Australian Patent Application 24976/99 to Acres Gaming Inc. Acres, as stated at page 17 thereof, broadly discloses a networked gaming machine environment wherein each gaming machine permits play of a primary game. There is also a secondary game playable upon a triggering event, the secondary game being common to all of the linked gaming machines. Acres further discloses a tertiary game playable upon a second triggering event, that tertiary game also being a “common” game. Whilst the display of the secondary game appears from the disclosure to be common to all of the linked gaming machines the play of the secondary game is initiated manually by a qualifying machine and the secondary game thus displayed and run and the output/result thereof is customized and unique and applicable only to that individual qualifying machine. Play of the primary game on the qualifying machine is suspended during this play of the secondary game, but the play is suspended only on that machine. To this extent Acres is perhaps best categorized as having a series of secondary games which, whilst displayed on a common display are really a series of individual games customized for only one of the network machines at a time. Acres does not disclose use of dual display gaming machines, but instead relies solely for display of the secondary game upon a single common display located above or in association with the linked gaming machines.
2. WO00/17825 to Mikohn Gaming Corporation discloses a networked gaming machine environment wherein there is a running secondary game (i.e. a secondary game which is run amongst a selected grouping of eligible machines and which awards sequential payouts as the secondary game progresses. The disclosure of Mikohn differs from that of Acres in that a primary and a secondary display is utilized on each gaming machine as well as an overhead display. The secondary display on each gaming machine is utilized to assist in the running of the secondary game. The primary display is used only for the primary game of each gaming machine.
3. WO99/03078 to Aristocrat Leisure Industries discloses a generalized networked gaming machine environment with a jackpot controller and associated display. This disclosure is concerned primarily with the manner in which individual ones of the networked gaming machines become eligible for a feature game. This disclosure is not concerned so much with topology or with the mechanisms of display, but is concerned primarily with trigger conditions. (The disclosure forms the basis of the Aristocrat “hyperlink” system).
4. WO97/12315 to Wintech & Bytecraft, by contrast, is concerned with topology and, more particularly with a particular form of jackpot controller which allows replacement or super position of a first video signal by a second video signal and discloses the concept of applying character based information (relating to jackpot amounts and the like) over a video signal or in substitution for the video signal. There is no disclosure of dual-monitor-type gaming machines nor the use of such dual display machines for a networked jackpot environment. This disclosure forms the basis of the “Paltronics” controller currently commercially available in Australia which may be utilized in embodiments of the invention to be described in the present application.
5. AU53370/86 to Frankovic discloses an early and fundamental form of a mystery jackpot controller environment wherein selection of the jackpot trigger amount is determined as a random value set between a lower value and a higher value. This particular algorithm is utilized in one preferred embodiment of the invention to be described in the present application.

None of the above referenced citations address the player isolation problem by the topology and display combination which is an object of at least preferred embodiments of the present invention.

Note:

The term “comprising” (and grammatical variations thereof) is used in this specification in the inclusive sense of “having” or “including”, and not in the exclusive sense of “consisting only of”.

### BRIEF DESCRIPTION OF INVENTION

Accordingly, in a first broad form of the invention there is provided a topology for a bank of linked gaming machines; each gaming machine of said bank of linked gaming machines comprising a dual display gaming machine having a first display for display of a primary game and a second display; said second display located above said first display on each said gaming machine; each said dual display gaming machine further including at least a machine logic unit which controls said primary game and its display on said first display; each said dual display gaming machine further including a display and controller unit which controls what is displayed on said second display; a jackpot controller including computing and display means linked to said bank of gaming machines, the gaming machines arranged to display on said main display selected game features wherein randomized events are caused to award a prize if a predefined event occurs, the controller being characterized in that it is arranged to provide a second game feature; said topology comprising said bank of linked gaming machines in electronic communication with said jackpot controller whereby at least a first predefined portion of data associated with said second game feature is displayed on said main display of at least selected ones of said bank of linked gaming machines; and wherein at least a second predefined portion of data associated with said second game feature is displayed on said second display of at least said selected ones of said bank of gaming machines.

Preferably, said first predetermined portion of data comprises animated graphics video data.

Preferably, said second predetermined portion of data comprises data video.

Preferably, said animated graphics video data comprises an animation of a horse race.

Preferably, said data video comprises horse allocation data; eligible machine data and jackpot amount data.

Preferably, said first predetermined portion of data is additionally displayed on an overhead display visible to players at each machine of said bank of gaming machines.

Preferably, said second predetermined portion of data is additionally displayed on an overhead display visible to all players at machines forming said bank of gaming machines.

Preferably, said jackpot controller includes a CPU, a memory device and input and output devices.

Preferably, said first predetermined portion of data is supplied to a graphics video splitter; said graphics video splitter receiving a main game video signal from said machine logic unit; said graphics video splitter arranged to supply either said first predetermined portion of data or said main game video signal to said first display of at least said selected ones of said gaming machines.

In a further broad form of the invention there is provided a topology for a bank of linked gaming machines; each gaming machine of said bank of linked gaming machines having at least a first display for display of a primary game; each said linked gaming machine further including at least a machine logic unit which controls said primary game and its display on said at least a first display; and wherein at least one of said linked gaming machines is provided with a second feature game software module; said second feature game software module of any one of said gaming machines selecting and controlling a common second feature game; a selection of said linked gaming machines participating in said second feature game.

Preferably, each machine in said bank of linked gaming machines is provided with a second display.

Preferably, each said machine is provided with a display controller unit which controls imagery displayed on said second display.

Preferably, said selection of said linked gaming machines participating in said second feature game includes all of said linked gaming machines.

Preferably, said selection of said linked gaming machines participating in said second feature game comprises a subset of said linked gaming machines.

Preferably, a jackpot triggering event on said any one of said linked gaming machines instigates selection by that machine of said common second feature game and said selection of linked gaming machines participating in said second feature game.

Preferably, said second feature game is displayed on a main overhead display module; said main overhead display module visible to all players of said bank of linked gaming machines.

Preferably, said second feature game is displayed on said second display of each of said selection of linked gaming machines.

Preferably, said second feature game software module is incorporated into software of said primary game; said primary game software and said second feature game software resident on a common memory device of said machine logic unit.

Preferably, each gaming machine of said bank of gaming machines is provided with a link interface module linked to a communication link and a site or jackpot controller.

Preferably, said topology further includes a main display controller; said main display controller caused to display said second feature game under initiation signal from said any one of said linked gaming machines.

In a further broad form of the invention there is provided a method for control of a second feature game; said second feature game provided to at least selected gaming machines of a bank of linked gaming machines; said method including the steps of:
(a) initiating a second feature game control sequence by one gaming machine of said linked gaming machine when a jackpot triggering event occurs on said one gaming machine,
(b) said one gaming machine acquiring state of play data from remaining said linked gaming machines over a communication link,
(c) said one gaming selecting at least a number of said remaining linked gaming machines as selected participating gaming machines in said second feature game.

Preferably, said state of play data includes current state of play of on said selected participating gaming machines.

Preferably, said state of play data includes last amount bet.

Preferably, said method includes the further steps of said one gaming machine:
(d) selecting a second feature game,
(e) transmitting data relevant to said selected second feature game for display on second display modules of said selected participating gaming machines,
(f) preventing new main games commencing on said selected participating gaming machines,
(g) initiating display of said second feature game.

Preferably, said second feature game is caused to be displayed on an overhead display module; said overhead display module visible to all players of said linked gaming machines.

Preferably, said second feature game is caused to be displayed on said second display of said one machine and on said second display of each of said selected participating machines.

In still a further broad form of the invention there is provided a software generated graphic display of a main game sequence or a second game feature sequence for play on gaming machines of a bank of linked gaming machines according to topologies of claims . . . to . . . wherein an outcome of said game is determined by an arrangement of elements at the conclusion of a game sequence in which said elements are randomized; each of said elements comprising a symbol within an hexagonal field.

Preferably, said reels are simulated as spinning about a common notional horizontal axis; said elements forming columns when said reels appear to be at rest.

Preferably, said arrangements of elements include a plurality of columns with elements of adjoining columns staggered relative one to the other.

Preferably, said elements are simulated to appear as elements distributed around the peripheries of a plurality of simulated spinning reels.

Preferably, said arrangements of elements include a plurality of rows with elements of adjoining rows staggered relative one to the other.

In still a further broad form of the invention, there is provided a software generated graphic display of a main game sequence for play on first displays of dual display gaming machines of a bank of linked gaming machines; said gaming machines controlled according to topologies such as those discussed above, wherein an outcome of said game is determined by an arrangement of elements at the conclusion of a game sequence in which said elements are randomized; a first collection of said elements disposed about the peripheries of an array of simulated inner reels; a second collection of said elements disposed about the peripheries of an array of simulated outer reels.

In yet a further broad form of the in invention there is provided a jackpot controller including computing and display means linked to an array of gaming consoles, the consoles arranged to display selected first game features wherein randomized events are caused to award a prize if a predefined event occurs, the controller being characterized in that it is arranged to provide a second game feature.

Preferably, the jackpot controller includes a CPU, a memory device and input and output devices.

Preferably, the display means include a controller display screen, a jackpot display screen and a pool display screen.

Preferably, the controller is adapted to accept input data from the array of consoles and is adapted to output data to the consoles.

Preferably, the controller stores data generated by the progress of play on the linked gaming consoles.

Preferably, the data collected by the controller includes the following data objects:
(a) The elapsed time from program initiation or from the completion of the last second game feature whichever is the later.
(b) The number and value of bets placed on each of the linked gaming consoles.

Preferably, the controller display screen is used to inform players at the consoles about the second game feature.

Preferably, the jackpot screen displays the type and amount of a prize comprising the jackpot.

Preferably, the second game feature is arranged to determine the winner of a jackpot prize.

Preferably, the jackpot may take a value which is constant.

Preferably, the jackpot value may increase incrementally from a base value to a maximum value.

Preferably, a second game feature may be triggered to occur according to any one of the following events:
(a) A random time interval from a preceding second game feature, the time interval defined as lying between a minimum and a maximum value.
(b) The value of a variable data object stored in the memory of the controller when this is equal to a pre-determined value.
(c) The value of a variable calculated from the data objects stored in the memory of the controller according to an algorithm when the calculated value is equal to a pre-determined value.

Preferably, the controller is arranged to select a number of players from the linked consoles as being eligible to play in the second game feature when this is triggered.

Preferably, the selected eligible players have the option to elect to participate in said second game feature by indicating to the controller their willingness to participate in the second game feature.

Preferably, a player selected by said controller as eligible to play said second game feature is automatically included in the play of said second game feature.

Preferably, the second game feature is a virtual horse race and wherein eligible players may be allocated a virtual horse by the controller.

Preferably, the number of horses to run in the second game feature is always larger than the number of horses allocated to eligible players.

Preferably, the winning horse in the virtual horse race is randomly determined.

Preferably, if the winning horse in the race was allocated to a player, that player wins the jackpot prize.

In still a further broad form of the invention there is provided a gaming system for play by players playing a primary game on one or more gaming machines of a plurality of gaming machines; said plurality of gaming machines electronically linked into a bank of gaming machines; a secondary game controller in communication with each of said plurality of gaming machines forming said bank; said secondary game controller controlling a secondary game for which said players can be eligible to play.

Preferably, said secondary game comprises a game viewable by all said players.

Preferably, said secondary game awards both a prize and the contents of an accumulation prize pool if a play of said secondary game is won by an eligible player of at least one gaming machine on a play of said secondary game.

Preferably, eligible players of said gaming machines for a play of said secondary game are selected by said secondary game controller.

Preferably, a player can be selected more than once by said secondary game controller for a play of said secondary game.

Preferably, a play of said secondary game is shown on a monitor associated with said secondary game controller.

Preferably, a play of said secondary game is shown on a display associated with each gaming machine of said plurality of gaming machines.

Preferably, a play of said secondary game is illustrated in animated form passing progressively from one to an adjacent one of said plurality of gaming machines.

In another broad form of the invention, in association with a bank of interconnected gaming machines, a secondary game feature which awards prize if a play of said secondary game feature is won by an eligible player of at least one gaming machine of said bank of interconnected gaming machines.

Preferably, eligibility of a player to participate in said secondary game feature is independent of the outcome of a primary game feature running on any one of said gaming machines.

Preferably, said secondary game feature is run by a secondary game controller running independently of any one of said interconnected gaming machines.

Preferably, said secondary game controller determines eligibility of a player to participate in said secondary game feature.

Preferably, said interconnected gaming machines are dual display machines having a first display for display of a primary game and a second display; said second display located above said first display.

Preferably, each said gaming machine includes at least a machine logic unit controlling said primary game.

Preferably, each said gaming machine further includes controller unit controlling imagery displayed on said second display.

Preferably, said bank of interconnected gaming machines include a jackpot controller; said jackpot controller including computing and display means linked to said bank of interconnected gaming machines, said gaming machines arranged to display on said main display selected game features wherein randomized events are caused to award a prize if a predefined event occurs, the controller being characterized in that it is arranged to provide said secondary game feature.

Preferably, said secondary game feature is run by a secondary game controller incorporated in at least one of said bank of interconnected gaming machines.

Preferably, said at least one of said bank of interconnected gaming machines is provided with a secondary feature game software module; said secondary feature game software module selecting and controlling a common secondary feature game; a selection of gaming machines of said interlinked bank of gaming machines participating in said secondary feature game.

Preferably, said secondary game feature is arranged for display on main display units of said gaming machines.

### BRIEF DESCRIPTION OF DRAWINGS

Embodiments of the present invention will now be described with reference to the accompanying drawings wherein:

FIG. 1 is a perspective view of a generalized first embodiment of a linked jackpot controller for operation in association with a group of linked gaming machines;

FIG. 2 is a view of a first display of a second game feature operable in association with the system of FIG. 1;

FIG. 3 is an alternate view of the second game feature of FIG. 2 displayed via the displays forming part of the group of interlinked machines of FIG. 1;

FIG. 4 is a view of a display of player allocations in relation to the second game feature operable in conjunction with the system of FIG. 1;

FIG. 5 is a block diagram of operation of the linked jackpot controller according to an embodiment of the invention in relation to a first example;

FIG. 6 is a flow diagram of operation of qualification for the second game feature in accordance with the example of FIG. 5;

FIG. 7 is a flowchart of qualification for the second game feature of the example of FIG. 5 operable whilst the second game feature is already is operating;

FIGS. 8A and 8B are block diagrams of a further generalized embodiment of a linked jackpot controller and associated bank of gaming machines;

FIG. 9 is a network interconnection diagram in accordance with a first particular example of the generalized embodiment of FIGS. 8A and 8B;

FIG. 10 is a network diagram of an alternative particular arrangement of the system of FIGS. 8A and 8B;

FIG. 11 is a third embodiment of a network interconnection arrangement for the generalized system of FIGS. 8A and 8B;

FIG. 12 illustrates diagrammatically a fourth embodiment of a network interconnection arrangement for the system of FIGS. 8A and 8B;

FIG. 13 illustrates a linked gaming machine topology in which the functions of second feature game selection and control are distributed within a bank of gaming machines,

FIG. 14 is a perspective view of a typical single gaming machine,

FIG. 15 is a representation of simulated sets of primary game inner reels and bonus feature outer reels for play as a second feature game,

FIG. 16 is a perspective view of matrices of elements in displayed portions of the set of inner reels and outer reels of FIG. 16, separated for clarity,

FIG. 17 is a front view of a gaming machine display showing the inner and outer reels of FIGS. 15 and 16 at rest,

FIG. 18 is a perspective view of the inner and outer reels of FIGS. 15 and 16 in which the elements of the inner reels are in the form of n-sided elements,

FIG. 19 is a perspective view of the inner and outer reels of FIGS. 15 and 16 in which the n-sided elements of FIG. 18 are nested.

FIG. 20 is a schematic representation of a control module, input keyboard and display for implementing the game embodiments of FIGS. 2 to 19,

### DETAILED DESCRIPTION OF PREFERRED EMBODIMENTS

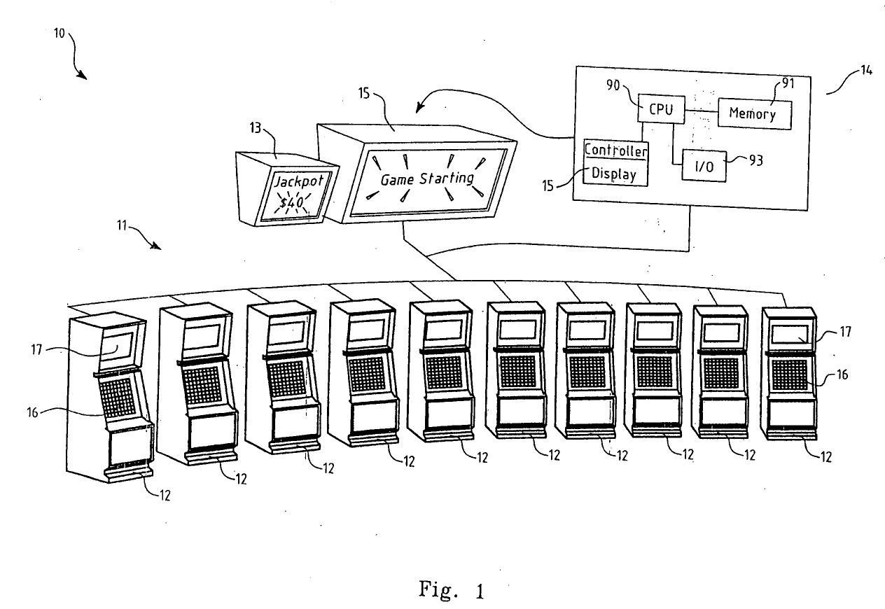

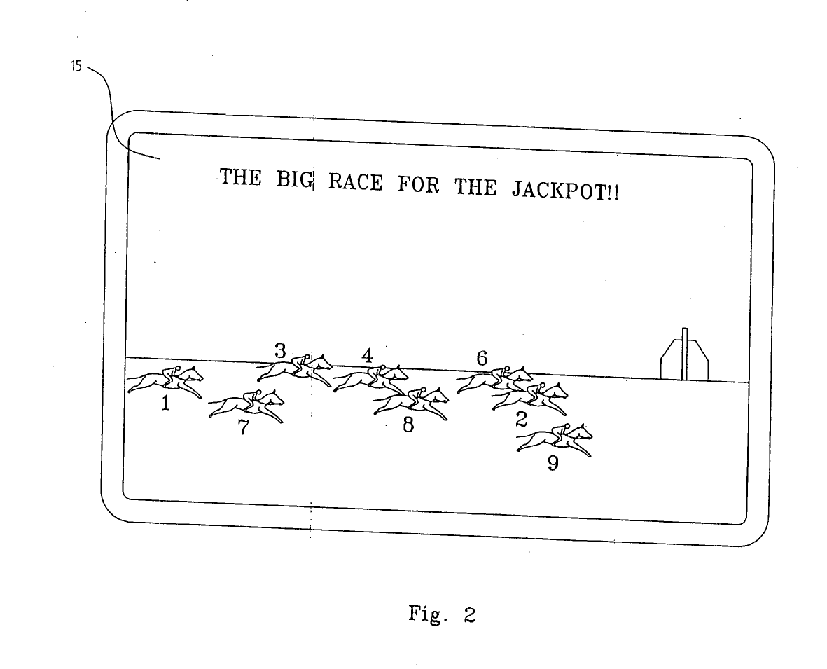

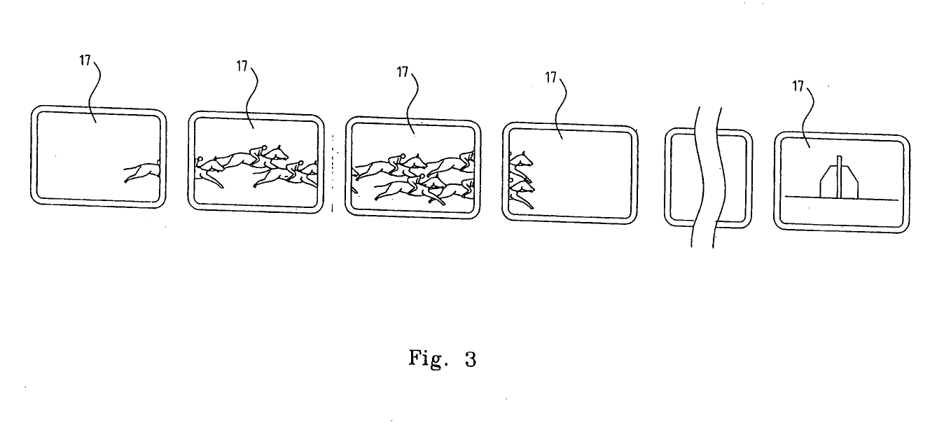

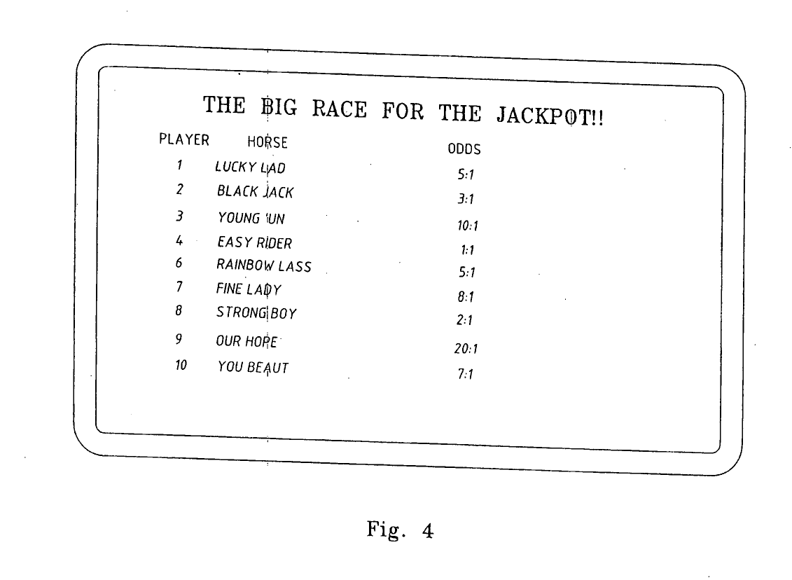

A generalized embodiment of a linked jackpot system 10 of the present invention will now be described with reference to FIGS. 1 to 4, following which a series of non-limiting examples will be provided by way of further amplification.

With reference to FIG. 1, the system of embodiments of the present invention is applicable to a plurality, or bank 11, of gaming machines 12, generally disposed in a line or arc such that a player (not shown) at any one of the gaming machines 12 has a view of a centrally disposed jackpot system 10 and more particularly a main overhead display 15 showing video output from the jackpot system 10. Each of the gaming machines 12 in the bank 11 is connected, in this non-limiting example, to a common jackpot controller 14 such that communication signals may pass between any one or all machines and the jackpot controller 14.

The jackpot controller 14 includes at least computing means in the form of Central Processing Unit (CPU) 90, memory 91 and main overhead display 15 means but may additionally be provided with audio output means and data entry means in the form of I/O 93. That is, the jackpot controller 14 includes a CPU 90, a data storage and retrieval device or memory 91 and input and output devices 93 and display 15.

The jackpot controller 14 in this example is further linked to, and controls at least one other (externally visible) display means: a “jackpot” data video display 13. The jackpot data video display 13 displays a jackpot prize which may be an amount of money, a number of free bonus games or some other form of prize.

It is the function of the jackpot controller 14 to provide a second game feature, (or “jackpot game”) which is additional to the individual games being played on the machines 12 in the bank 11.

A second feature game sequence will now be described with reference to the jackpot system 10 illustrated in FIG. 1. Individual gaming machines 12 in the bank 11 may be used in the normal manner by players who select to play any one from a plurality of standard or primary games available on each gaming machine 12.

As bets are placed on a gaming machine 12, a percentage of the money deposited is transferred to the jackpot controller 14 or otherwise made available for winnings associated with the outcome of the second feature game. In a particular form the jackpot controller 14 maintains a record of all data related to the bets and money accruing, including the gaming machine which generated the bet and the numbers of bets placed on each gaming machine by players.

The jackpot controller 14 is activated to initiate a second feature game depending on the occurrence of a predetermined event or sequence of events which may include one or more of:
1. A random event (including symbols or numbers occurring in base (main) games or secondary feature or bonus games on each machine 12).
2. The statistically determined status of a data object within the jackpot controller.
3. The status of a combination of machines.
4. The coinciding of a value N of an incrementing counter with a randomly pre-selected hidden value M where both N and M lie in a range known to the players.

The triggering of a second feature game is indicated to the players currently playing on the bank of gaming machines and no new bets may be placed until the second feature game preparation is completed.

The second feature game may take a number of forms of “games of chance” such as roulette wheels, chocolate wheels and the like, but by way of example, the second feature game method here described is in the form of a horse race.

In preparing the game, the jackpot controller 14 determines the eligibility of players to participate in the race and displays this selection at least as data video either on the main overhead display 15 or on data video display 13, or on the individual gaming machines such as first display 16 or second display 17 of a dual display machine.

In one preferred form of the invention those players who are indicated as eligible may agree to play the second feature game. They may indicate their participation by the depressing of a button on their consoles for example. Players who are selected as eligible but who do not indicate their intention to play may now continue with individual primary games on their gaming machine.

The jackpot controller 14 now assigns a horse to each of the participating players and runs the race comprising the second feature game in this instance. The race may be displayed on the jackpot controller main overhead display 15 or may be arranged to progress along the bank of individual gaming machine first displays 16, second displays 17 or both. Alternatively, or in addition, the race progress can be displayed in its entirety on each of displays 16, 17 of the participating players' machines.

In this instance, the number of horses in the race is equal to a greater than the number of eligible players. The race is run and the winning horse identified.

In one form the winning horse is one that was allocated to a participating player, a jackpot prize is issued by the jackpot controller 14 to that player. This may be done by directing the player's gaming machine to pay out the jackpot prize amount if this is money, or set the gaming machine to allow the free number of second feature games, or direct the player to collect his winnings in some other way.

The data video display 13 remains at the constant jackpot amount or can be re-set to a minimum amount which subsequently accumulates itself in a predefined manner.

At the next triggering of a second feature game where the jackpot in the preceding game was not won, the race will be run for the jackpot prize amount.

The methods by which a second feature game may be triggered by the jackpot controller 14 and the method of selecting participants and the allocation of horses as well as possible means of disbursement of the prize will now be described in more detail.

Triggering of a Second Feature Game.

The following are possible, non-limiting ways of triggering the second feature game:
1. The jackpot controller includes a random number generating facility to generate a number within the range N to M. The second feature game is triggered when a selected parameter of the system reaches the generated random number. This parameter may be for example the accumulating value of all bets placed by all machines in the bank. The range N to M is chosen such that the probability of a triggering event occurring is at an average frequency to maintain the interest of the players at the gaming machines.
2. The second feature game is triggered when the jackpot controller calculates that the betting density has reached a predetermined level, that is, the average number N of all bets placed on all the gaming machines in the banks within a time period T exceeds a value X.
3. The second feature game is triggered when the jackpot controller detects that a sufficient number of machines in the bank have been in continuous use over a time period T.
4. The second feature game is triggered by an incrementing counter when the value of the count coincides with a randomly selected value. The counter is visible to the players and the minimum and maximum values are displayed. The randomly selected value is not known to the players but is known to lie between the minimum and maximum values of the counter.
   Selection of Eligible Players for the Second Feature Game.

The following are non-limiting ways in which players of the gaming machines comprising the bank of gaming machines may be selected as eligible to play the second feature game:
1. The jackpot controller may be programmed to select as eligible participants for the game, all of the currently occupied gaming machines.
2. The jackpot controller may be programmed to select as eligible participants for the game, those gaming machines which have placed a sufficient number of bets over a given period.
3. The jackpot controller may be programmed to select as eligible participants for the game, those gaming machines which have placed bets to a sufficient value over a given time period.
4. The jackpot controller may be programmed to select as eligible participants for the game a random sub-set of the available players.
5. A participant may be qualified as eligible in accordance with the nature of the participant's bet in relation to the main or first game on the console or gaming machine that that person is currently playing.

In a particular form the bet can be, for example, a maximum line bet.

Allocation of Horses to Participating Players

To add realism to the game, the horses in the race may include identifiable “favorites” with this information displayed as starting odds for each horse on the jackpot controller main overhead display 15 or on jackpot data video display 13. Although in the actual running of the race the winner will be randomly selected, the allocation of “favorites” will add further interest and excitement to the game.

The following are non-limiting ways in which available horses for a play of the second feature game may be allocated to players who have been selected as eligible to play the second feature game:
1. (a) The allocation of all horses by the jackpot controller to eligible participating players may be purely random.

(b) In a particular form, a player may be allocated more than one available horse, while other eligible players may be allocated no horse.
2. The players may be allocated horses on the basis of horses with the shortest odds progressively matched to players with the highest betting record.
   Disbursement of Prizes Won in a Second Feature Game
1. The jackpot amount may be credited to the gaming machine of the winning player.
2. The jackpot may be made payable modified by the use of the odds of the winning horse acting as a multiplier.

Specific but non-limiting examples of a linked jackpot system for use in association with a plurality of linked gaming machines will now be provided.

### EXAMPLE 1

Linked Progressive Mystery Jackpot with Jackpot Pool System

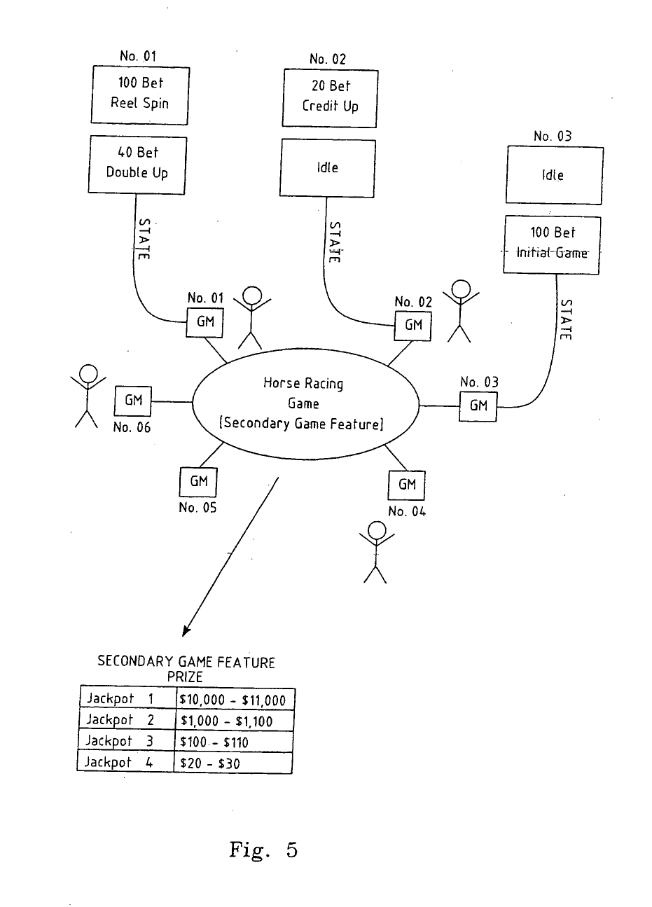

With reference to FIGS. 5, 6 and 7:—

A horse racing game with 8 horses is linked to 6 poker machines. (It will be appreciated that the number of horses and poker machines can be varied whilst still remaining within the ambit and spirit of the game). Players participate in normal games run on each individual machine, as well as being able to win a special linked jackpot associated with the bank of machines.

In this example, there are 4 types of normal jackpots to be won. These 4 jackpots are set to be won between the following values;

| | |
|---|---|
| Jackpot 1 | $10,000-$11,000 |
| Jackpot 2 | $1,000-$1,100 |
| Jackpot 3 | $100-$110 |
| Jackpot 4 | $20-$30 |

Each normal jackpot increases by $0.05 when a $1 bet is made on a machine linked to the horse racing game.

### Example Play of Game including Second Feature Game

With reference to FIG. 5, of the 6 poker machines, machines No.01, No.02, No.04, No.06 have players participating while machines No.03 and No.05 have no players.

The player on machine No.01 triggers Jackpot 3. At present the value of Jackpot 3 is $110. The player on No.01 is assigned a horse. The other horses can be assigned to a maximum of 5 other players who were participating in a normal or primary game when the player on No.01 triggered the normal jackpot.

Selection Process

In a simplified form eligible machines are selected based on whether there has been activity recently on the machine, for example whether turnover has incremented in the last three seconds. If there has been such activity then the machine is selected as eligible.

Hence, in this instance, machines 01, 02, 04 and 06 are selected. Machines 03 and 05 are not selected because there is no play on the machines at the time of jackpot prize trigger.

The eight horses can be assigned randomly or, for example, on the basis of a weighting favouring those machines which have had, for example, higher turnover than others within a predefined time (for example since the last time a jackpot was triggered).

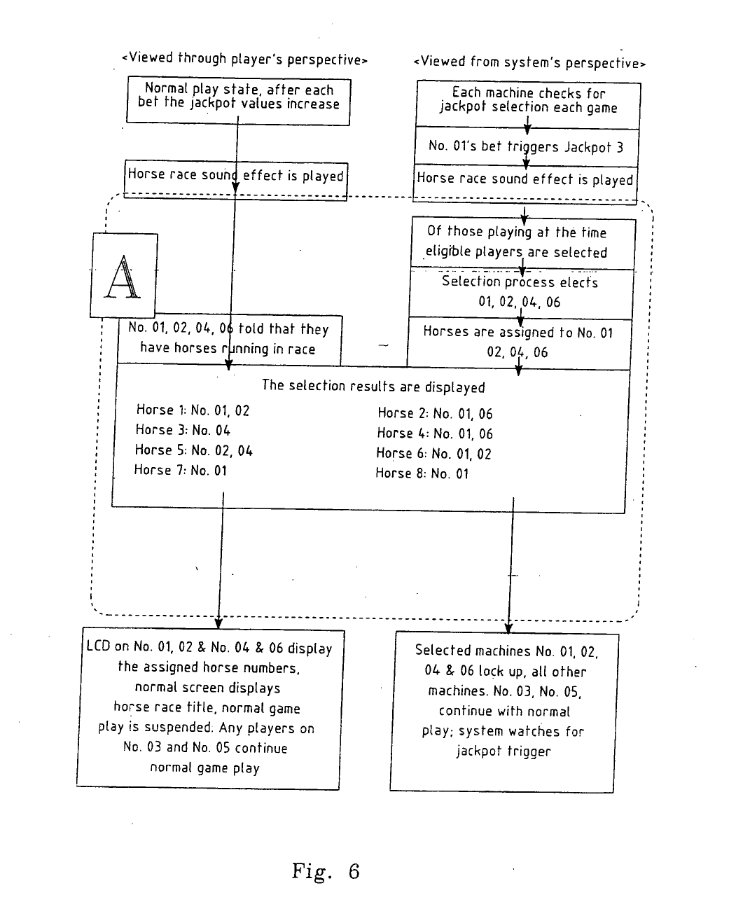

With reference to FIG. 6, in this instance, all horses are allocated to eligible machines as outlined in the FIG. 6.

Even if waiting is utilised as part of the selection process it can still be that the machine which triggered the jackpot feature in the first place and/or that machine with the highest turnover history may not be allocated as many horses as other machines.

The machines of players that have been selected to participate in the horse race are locked up, in the Top Box LCD or second display 17 (refer FIG. 1) the player's horse number (or numbers) is displayed. On the normal screen or first display 16 (refer FIG. 1) the horserace game title is displayed and no normal game play can be undertaken.

Players who weren't selected for the horse race can play normal games on their respective machines.

If a player who wasn't selected for the race comprising the second game feature continues playing while the race for Jackpot 3 is underway and that player triggers Jackpot 4, the same process as above occurs. The player's machines that have been selected lock up, and on the second display 17 a message saying “eligible for next race” is displayed.

The race starts and the machine with the winning horse wins Jackpot 3.

In this example, horse number 8 won the race and machine 01 is paid the jackpot 3 amount.

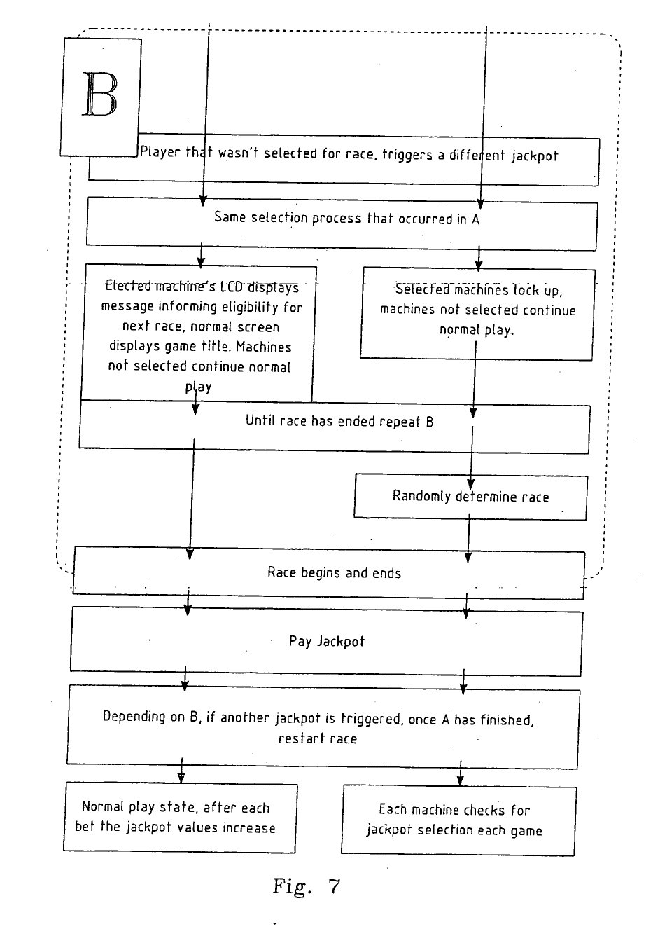

FIGS. 6 and 7 illustrate the above described example behaviour of FIG. 5 in flowchart form.

### EXAMPLE 2

Generalised Linked Progressive Mystery Jackpot with Jackpot Pool System applied to Specific Network Interconnection Systems

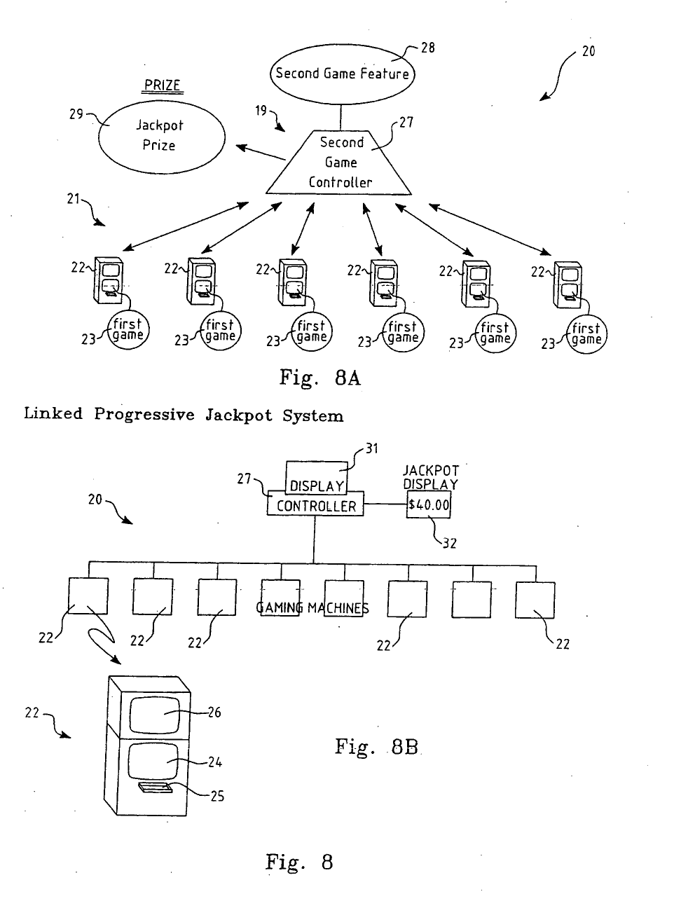

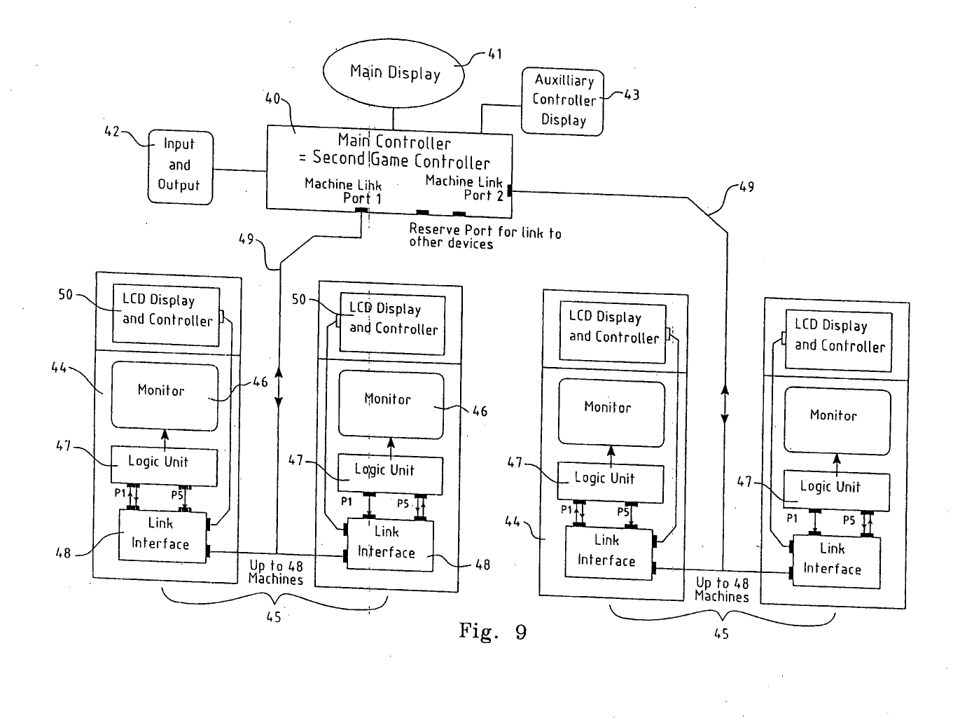

With reference to FIGS. 8, 9, 10 and 11 a second generalized embodiment of a linked jackpot system 20 together with three examples of suitable networking interconnections between machines, the jackpot controller and various displays will be described. In each these first three examples of networking interconnections, the jackpot controller is a single unit, external to the linked gaming machines.

Initially with reference to FIG. 8 there is illustrated a second generalized embodiment of a common jackpot controller 19 and associated bank 21 of gaming machines 22.

With particular reference to FIG. 8A the basic concept involves each of the individual gaming machines 22 being enabled to play at least a first or primary game 23. In effect the primary game 23 is a machine game playable on each respective gaming machine 22 independent of the common jackpot controller 19. With reference to the inset of FIG. 8 a typical gaming machine 22 includes an at least first display 24 which displays the results of primary game 23 after the game is instigated by a player (not shown) typically via operation of one or more buttons, keys or the like on keyboard input panel 25. Most usually the at least first display 24 displays a simulation of a spinning reel based “poker” or similar symbol-based game. In many jurisdictions the probabilities of win and payout on the primary game 23 are regulated.

With further reference to the inset of FIG. 8 each gaming machine 22 may include a second display 26 which may be arranged to display variable images under the control of an electronic controller. In one form the second display 26 can take the form of a CRT or like cathode ray tube based display. In alternative forms it can take the form of an LCD display. The advantage of such electronically image-manipulatable displays is that what is displayed on the display can be changed readily under the actions of an electronic controller which, in turn, is controlled by software.

Reverting to FIG. 8A the linked jackpot system 20 includes a second game controller 27 which controls the playing of and outcome of a second feature game 28.

The second feature game provides for an outcome in the form of a prize or jackpot prize 29.

In a particular form more than one jackpot prize 29 may be available at any one time. It can also be that those players not eligible for a current play of a second feature game 28 may continue to play their respective gaming machines 22 all the while being eligible to win others of jackpot prize 29 via a further second feature game 28 yet to be run.

In FIG. 8A the communication topology is such that each gaming machine 22 forming bank 21 communicates directly with second game controller 27. However, other topologies are possible as shown in FIG. 8B and as will be described in further detail below.

With particular reference to FIG. 8B a communication topology is shown wherein gaming machines 22 are linked into direct communication with each other as a bank 21 and also with second game controller 27. In this particular topology second game controller 27 communicates the progress of second feature game 28 on second feature game progress display 31. The currently available jackpot prize 29 is displayed in prize display or jackpot prize display 32.

Similarly, the current value displayed on jackpot prize display 32 is the current prize or jackpot prize 29 available via a play of second feature game 28 under the control of second game controller 27.

An exemplary play of the linked jackpot controller system 19 illustrated in FIG. 8 wherein the second feature game takes the form of a horse race and wherein second display 26 on each gaming machine 22 takes the form of an LCD display in a “top box” portion of each machine 22 is as follows:

Exemplary Run of Second Feature Game—Horse Race

1. Players bet on normal or primary game, percentage of turnover is transferred to jackpot controller,
2. A random mystery jackpot is set to trigger between certain values, these values being in a range that results in the jackpot being triggered regularly,
3. Once mystery jackpot has been triggered a second feature game starts,
4. Jackpot controller randomly selects winning machine or machines,
5. To be eligible for mystery jackpot, player(s) must participate in a second feature game (eg. Horse race),
6. Player(s) is randomly pre-selected a horse by the controller, race is displayed on large display or on LCD display in top box,
7. If using LCD display the race could be run across a bank of machines,
8. Player with the winning horse is entitled to mystery jackpot value($40.00),
9. The losing player(s) return to the normal game,
10. After either a win or loss occurs the jackpot controller resets the mystery jackpot value to its minimum value

### Exemplary Communication Topologies

In conjunction with the description of FIG. 8 and with particular reference to each of FIGS. 9, 10 and 11, specific inter-machine and inter-controller topologies will now be described:

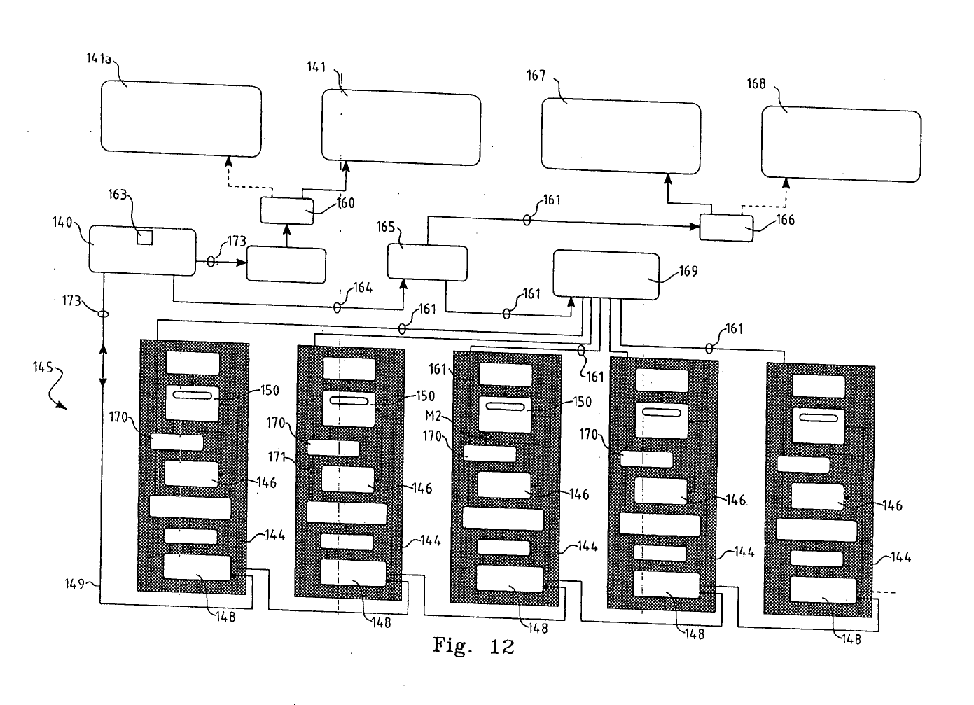

In this instance, in each of the topologies of FIGS. 9, 10 and 11, the second feature game controller takes the form of main controller 40. In a particular form main controller 40 can be implemented on a personal computer or like computing device and adapted to drive a main overhead display 41 which can act as a second feature game progress display and can also act as a prize display. In a particular form these two functions are split across two separate displays with the main or controller display dedicated to displaying progress of the secondary feature game in the form of animated graphics video and the auxiliary display or jackpot data display dedicated to displaying data video associated with statistics associated with the second feature game such as, for example, jackpot values, machines selected as eligible to play and related alpha numeric data. This split arrangement has been described in earlier embodiments and a further example of it is described in the further embodiment associated with FIG. 12 to be described later in this specification. The main controller 40 can be programmed or otherwise manipulated via input output unit 42 and auxiliary controller display 43.

In the instance of each of FIGS. 9, 10, 11 each gaming machine 44 forming part of a bank 45 includes a first display 46 for display of progress and results associated with a first or primary game playable on each respective gaming machine 44. The first game is controlled by means of a machine logic unit 47. Typically the logic unit 47 will communicate with first display 46 and will also communicate with a player by means of a keyboard such as keyboard input panel 25 of FIG. 8. The logic unit 47 also communicates with the cash in and cash out systems of the gaming machine 44 including, for example, bill validator units and coin transport systems.

The logic unit 47 also communicates with a link interface 48. The link interface 48 is the intermediary for communication via communication line 49 with all machines 44 forming bank 45.

In the instance of the topology of FIG. 9 each link interface 48 is the only means of communication between each machine 44 and main controller 40 by way of communications line 49.

In the instance of FIG. 9 the link interface 48 is also utilized to communicate with a second display in the form of an LCD display and second display controller 50 mounted, in this instance, for viewing in each machine 44 above first display 46 of each machine 44. Such machines are sometimes referred to as “dual monitor or dual display” machines.

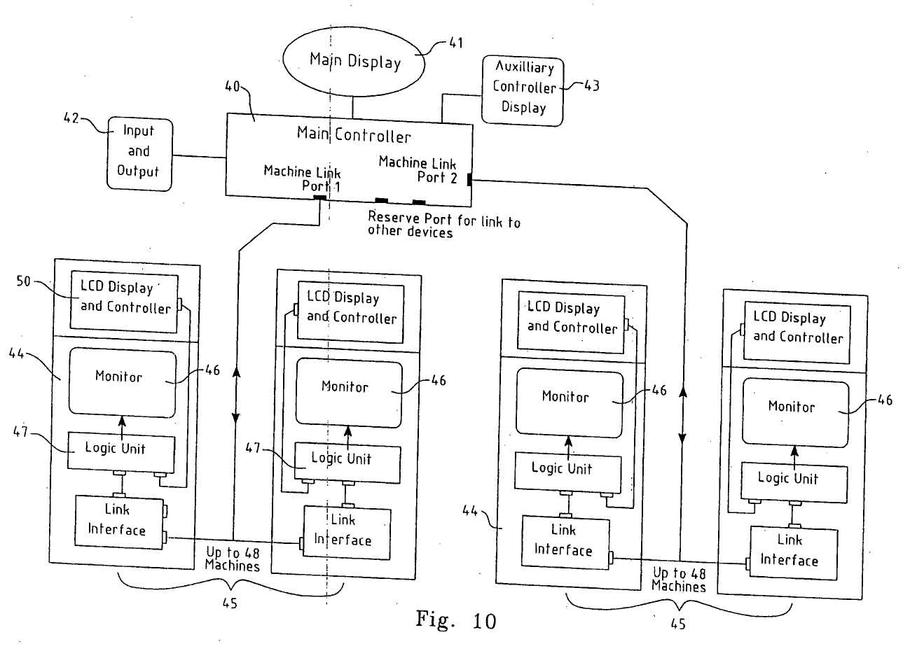

In the instance of FIG. 10 communication with the LCD display and second display controller 50 of each machine 44 is via each respective machine's logic unit 47.

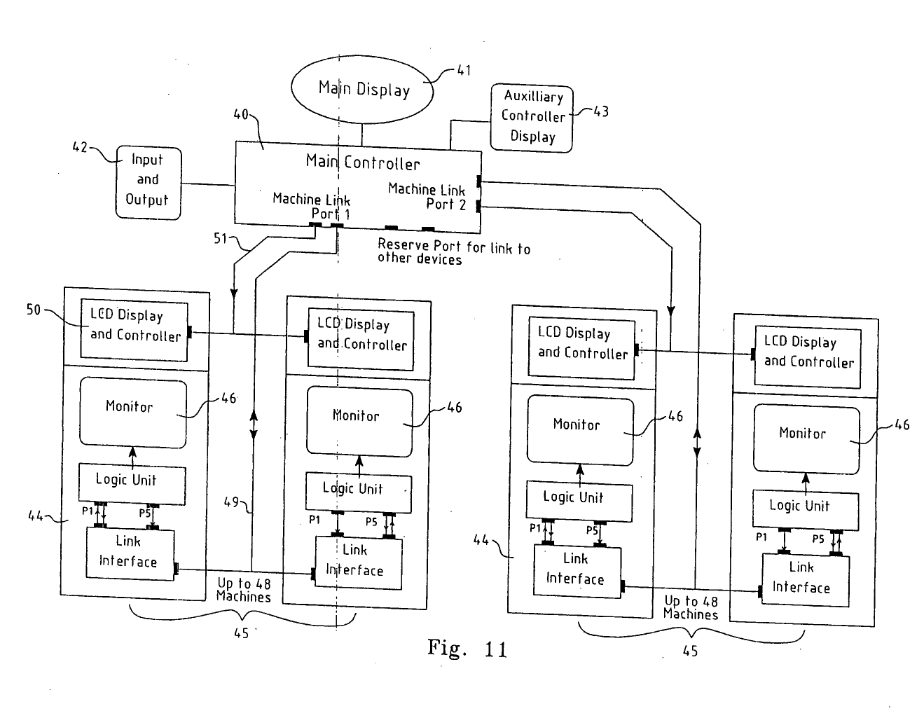

In the case of the topology of FIG. 11 communication and control of the LCD display and second display controller 50 of each machine is run directly from main controller 40 by means of second communications line 51 thereby providing fully independent control of the second display on each machine in the form of LCD display and second display controller 50 without the requirement to communicate via the link interface and logic units of each machine on communications line 49.

### Video Splitter Embodiment

With reference to FIG. 12 there is illustrated a further embodiment wherein like components are numbered as for the embodiment of FIGS. 9, 10 and 11 except in the 100s series, so for example, first display 46 of FIG. 9 becomes first display 146 of FIG. 12.

This embodiment is based on the above described communication topology of FIG. 9 as far as data video is concerned combined with utilisation of additional video splitters to permit display of animated graphics video on each of first displays 146 of each machine 144 within each bank 145 in the manner contemplated in the earlier described generalised embodiment.

As for previous embodiments, a bank 145 of linked gaming machines 144 has associated with it a main controller 140 which controls the second feature game (in preferred embodiments a horse race game) taking the form of a jackpot game as previously described with reference to any one of the previous embodiments and at least components of which are displayed on main overhead display 141.

In this embodiment more than one main overhead display 141 can be utilized by using a video splitter 160 which splits or divides the incoming video signal to main overhead display 141 and allows an identical image to that displayed on main overhead display 141 to be displayed on additional main overhead displays 141a. This is particularly useful where it is desired to place main overhead displays 141 and 141a back to back and located immediately above the bank 145 of gaming machines 144.

In addition, as alluded to earlier, the display of the jackpot game can be split by function of data making up the totality of the second feature game 128. Specifically the total information which a player requires comprises the running of the game itself which is best implemented as an animated graphics video (in this instance of the running of a horse race) together with associated what might be termed statistical data such as which machine is allocated which horse, which machines are eligible for the second game and the results of the second game and the awards paid as a result of the second game. This statistical-type data is termed “data video” and can typically be displayed as alpha numeric symbols.

In the instance of FIG. 12 the data required for the data video component is generated by main controller 140 which in a particular embodiment can comprise an industry-standard “paltronics” jackpot controller. The animated graphics video associated with the running of the secondary game is allocated to separate graphics controller 165. Collectively main controller 140 and separate graphics controller 165 perform the function previously allocated and described with reference to earlier embodiments of controller 14, 27 and 40 of earlier-described embodiments. This splitting of function is further assisted by splitting of video signals thereby to more effectively distribute information concerning the second or jackpot game to the individual players of eligible (and indeed non-eligible) machines in order to address the player isolation problem previously referred to in this specification.

More specifically in the arrangement of FIG. 12 jackpot game data 163 is determined by second feature game main controller 140. Portions of this data provided to video splitter 160 display on main overhead displays 141, 141A as data video as previously described.

In addition or in the alternative the data video signal 173 is also supplied to link interface 148 and from there, as shown in FIG. 12, to the LCD display and controller 150 for display on the second (upper display in a dual display machine) display of each eligible machine 144. In an alternative particular preferred form the data video signal 173 may also be supplied to the LCD display and controller 150 for display on the second display on each non-eligible machine of the linked array.

A first predetermined portion 164 of jackpot game data 163 is utilized to direct a separate graphic controller 165. The separate graphic controller 165 generates animated graphics video signal 161 which, in a preferred form, comprises a video signal of an animated horse race. The animated graphics video signal 161 can be fed to a first graphics video splitter 166 whereby the graphics signal can be displayed simultaneously on both a first overhead display 167 and a second overhead display 168.

In addition, or in the alternative, the graphics video signal 161 can also be fed to multiple video splitter 169 which provides simultaneous parallel graphics video signals 161 to a second graphics video splitter 170 located in each gaming machine 144 of bank 145.

The second graphics video splitter 170 receives also a primary game video signal 171 from machine logic unit 147. The second graphics video splitter 170 can feed either graphics video signal 161 or primary game video signal 171 to the first display 146. In a preferred form of operation the second graphics video splitter 170 feeds primary game video signal 171 to first display 146 except when a secondary game is to be displayed at which time it receives a switch signal 172 from LCD display and controller 150 (received in turn from link interface 148 and main controller 140) which causes second graphics video splitter 170 to instead feed graphics video signal 161 to first display 146 for the duration of the run of the jackpot game. In a particularly preferred embodiment the run of the jackpot game comprises the run of a horse race having a plurality of competing horses visually depicted in a race track context. Other sources of signal for second graphics video splitter 170 are also possible including directly from logic unit 147.

A particularly preferred example of a second feature or jackpot game run by main controller 140 in respect of bank 145 of machines 144 in FIG. 12 is as follows:

In the course of players playing a main game displayed on displays 146 turnover amounts are supplied to main controller 140 via communication line 149. Main controller 140 operates at least one mystery jackpot, data in relation to which is displayed as data video on at least LCD displays and controllers 150 of each machine 144 and optionally also on main overhead displays 141, 141a. When turnover contributions reach a predetermined amount selected by main controller 140 lying between a first lower predetermined value and a second predetermined upper value then main controller 140 signals the commencement of a second (jackpot) game and performs two initial functions:
1. It determines which machines are eligible for the second game. In this instance selection is based on those machines in which a change in turnover amount signal is received within a predetermined time, for example 3 seconds of the current time; and
2. A winning value is randomly selected. In the instance of the horserace example a winning horse number is randomly selected from, for example, a field of nine horses.

In an alternative form triggering of the jackpot game can be symbol driven from results occurring on a main game, for example the occurrence of a particular symbol or group of symbols on a main game or on a second game awarded as a result of the play of the main game on a given machine. In a particular form the main game can be a ‘Ten Reel’ game of the type described in applicant's Australian Patent Application No. 2005902074, the disclosure of which is incorporated herein by cross reference, and which is further described hereunder in the First Embodiment of the section of the specification headed Examples of Game Implementation. A Second Preferred Embodiment under the same head further describes another particular form of a main game can previously disclosed in the applicant's Australian Patent Application No. 2004901710, also incorporated herein by cross reference.

Play of the main game on each eligible machine is then terminated and horses attributed to each machine (either in random fashion or by a formula weighted according to turnover on each machine within a predetermined period of time) are displayed on the LCD display and controller 150 of each machine and optionally on main overhead displays 141, 141a as data video in the manner previously described. The winning horse number is communicated by main controller 140 via first predetermined portion 164 to separate graphics controller 165 which then selects a video sequence from a library of video sequences that will show the selected horse number as the winning horse. The animated graphics video signal 161 corresponding to that video sequence is then displayed on each first display 146 at least of eligible machines and optionally also on overhead displays 167, 168. Once the video sequence has finished that machine which had the winning horse number is awarded the jackpot amount and normal play then resumes on all machines until another jackpot sequence is triggered by turnover amount again reaching a trigger value as determined by main controller 140.

Distributed Second Feature Game Control Topology

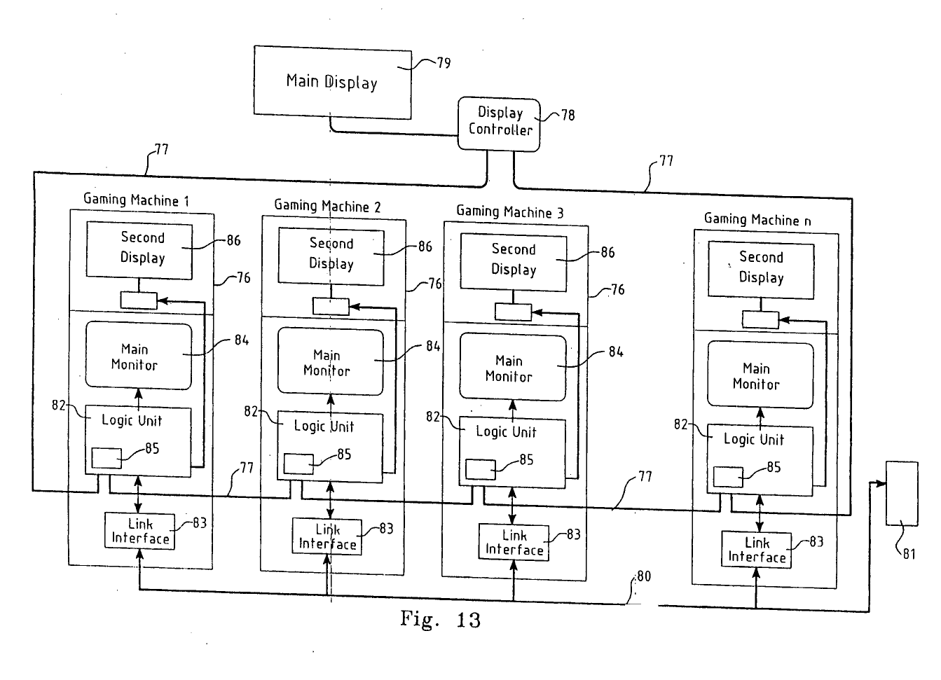

With reference to FIG. 13, there is illustrated a topology for a jackpot system 75 in which each of a bank of n gaming machines 76 are interlinked. Transfer of data between the interlinked machines may be by means of a first communication link 77 or, optionally via a link interface 83 in each machine communicating with a site or jackpot controller 81 over a common protocol of an inter-gaming machine component 80.

First communication link 77 further allows exchange of data between each of the machines 76 and a main display controller 78. Main display controller 78 is linked to an main overhead display 79 which is observable by all the players (not shown) of the n gaming machines 76.

Each machine 76 is provided with its own logic unit 82 for the control and display of a primary or base game on the main or first display 84 of the machine as previously described. However, in this topology, each logic unit 82 includes a second feature game software module 85 the function of which is analogous to that aspect of the jackpot controllers described in previous embodiments above in which the second feature game was under the control of a jackpot controller. Thus the site or jackpot controller 81, only functions in this arrangement as a standard jackpot controller, handling jackpot pools (levels), jackpot increments and payments of jackpot prizes.

Second feature game software module 85 is incorporated into the main game software located in the main processor of the logic unit 82. Each feature game software module 85 is used to trigger jackpot events and communicate with any or all of the other linked gaming machines.

When a jackpot triggering event occurs on a particular machine, the second feature game software module 85 of that machine makes a selection of the second feature game to be played, selects other machines in the bank for participation in the second feature game and signals the start of the game to the main display controller 78. The jackpot triggering method may be any means such as commonly used in gaming machines, for example through a random number generating process or some predetermined outcome of a main game played on the machine.

Usually, the second feature game will be displayed on the main overhead display 79, but may alternatively be displayed on either the main or first displays 84 or on the second displays 86 of dual display machines.

A preferred procedure for the playing of a second feature game with a jackpot system of the present embodiment will now be described:
1. A jackpot event is triggered on gaming machine A of a bank of n interlinked gaming machines.
2. Gaming machine A communicates with all other machines over the first communication link 77, indicating the event has occurred and interrogating the status of the other machines.
3. In answer to the interrogation, the other machines return to gaming machine A information of the current state of play of each machine, including at least the last amount bet and the seconds elapsed since last play.
4. Gaming machine A then selects a number of the other machines in the bank as eligible for participation in the second feature game to be played. This selection may be random or may be weighted according to the information received in step 3 above.
5. Gaming machine A notifies the selected gaming machines of their election to play the second feature game and causes display of information regarding the game to appear on either the second displays 86 of each participating machine, or on the main overhead display 79, or both. On receipt of the notification of selection, the selected machines lock up, that is no primary game can be started on those machines until the second feature game sequence runs its course.
6. Gaming machine A also sends a signal over first communication link 77 to the main display controller 78 to start display of the second feature game.
7. At the conclusion of the second feature game the gaming machine which wins the game notifies the site controller 81 via the inter-gaming machine component 80 and receives payment for the win over the same link.
8. All machines now revert to individual status in that primary games may again be initiated on each machine.

The second feature game outcome, although clearly not apparent to any of the players prior to the conclusion of the game, is determined by the gaming machine on which the jackpot triggering event occurs and which initiates the second feature game. The identity of the winning machine is transmitted via the link together with the game information, for display at the end of the second feature game sequence.

### EXAMPLES OF GAME IMPLEMENTATION

### First Preferred Embodiment

A first particular second feature game implementation which may be displayed as described above and which is generated and controlled by one of the gaming machines in a bank of gaming machines will now be described.

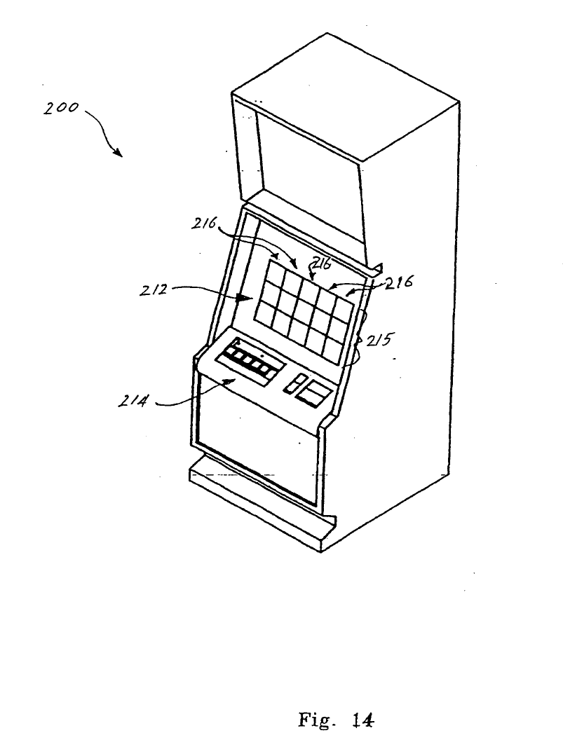

With reference to FIG. 14, a typical gaming machine 200 is provided with an electronic display module 212 and control panel 214 provided with control buttons and coin and/or bill input means. Players of primary games on any of the gaming machine 200 of a bank of linked machines, may place bets according to rules displayed on the machines. Typically a primary game played on the machines consists of the simulated randomised spinning of a number of coaxial reels, each divided into segments or elements wherein each element is adapted to display a predetermined symbol.

The display module 212 then shows portions of the reels such that when the reels are at rest, the display consists of a matrix of elements 215 in which the columns 216 comprise a number of the segments of each reel, in this example forming a five column by three row matrix of elements 215. A predetermined arrangement of symbols displayed in the matrix of elements 215 may confer a winning outcome of the game.

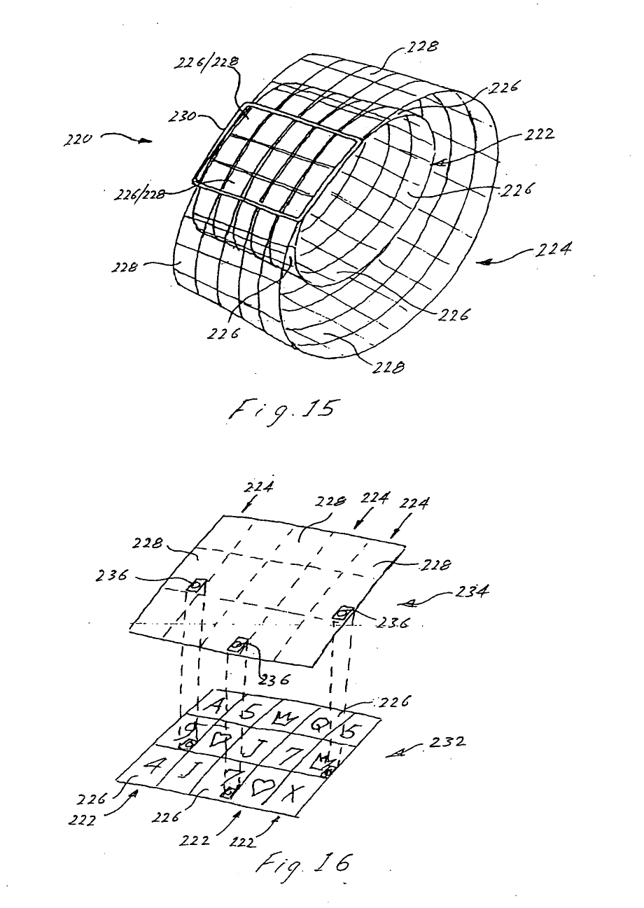

When a second feature game is triggered by one of the linked machines, that machine arranges for the play of the second feature game either on the primary or first display or on the top box or second display of each machine in the bank. With reference to FIG. 15, the second feature game display comprises a display 220 of two sets of simulated coaxial reels, a first set of inner reels 222 and a second set of outer reels 224. The inner reel elements 226 carry symbols (not shown) determinant of a primary game while the elements 228 of the outer reels 224 carry symbols (not shown) defining a second feature game.

As can be seen in FIG. 15, the two sets have an equal number of reels, five each in this example, and their disposition is such that, within the confines 230 of the display module 212, they are in close apparent proximity and the corresponding elements 226 and 228 of the inner and outer reels respectively are in registration. That is, an equal number of elements of each corresponding inner and outer reel form overlying columns of a first and second matrix of elements.

Although for illustrative purposes FIG. 15 shows the dividing lines between the outer reels 224 and their divisions into outer reel elements 228, it will be understood that these may be notional divisions and that the function of the outer reels may be achieved without these divisions actually appearing in the display. Thus the outer reels 224 may be considered as comprising of transparent film on which are placed, in selected notional elements, the bonus symbols 236 of the second feature game.

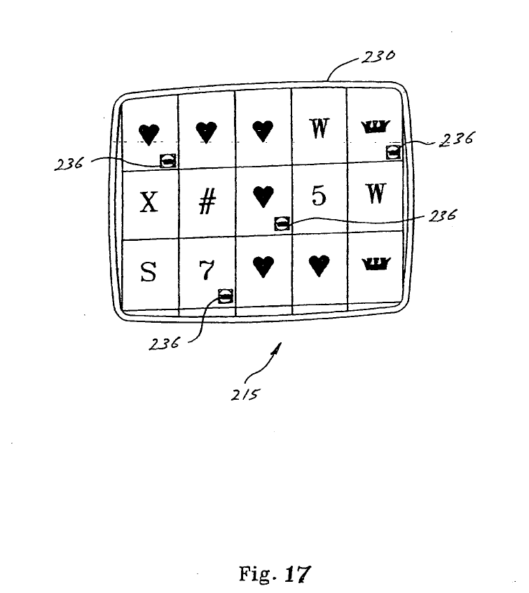

FIG. 16 shows the inner first matrix 232 formed in the display by the inner reels 222 and the outer second matrix 234 formed by the outer reels 224, separated here for clarity. The notional divisions between the outer reels 224 and their elements 228 are shown by dashed lines. As shown in FIGS. 16 and 17, only some of the elements 228 of the outer reels formed by the notional divisions, are provided with bonus symbols 236 for the second feature game. The bonus symbols 236 are so located within the notional elements 228, for example in a corner of the element, that when the outer second matrix 234 overlies the inner first matrix 232, the bonus symbols 236 of the second feature game do not obscure the symbols of the primary game.

At the initiation of play of a primary game on the gaming machine 200, both sets of reels 222 and 224 are simulated to spin simultaneously such that the angular velocity of the inner and outer sets of reels are equal. Thus, even though the outer reels 224 may comprise significantly more elements than the inner reels 222, during passage through the confines 230 of the display module 212, bonus symbols 236 on the second feature game outer reels 224 will appear to remain in relative registration with the inner reel elements 226 and symbols of the primary game inner reels 222.

It will be apparent that during play of a second feature game, for each subsequent passage through the display by the elements of the inner and outer reels, the conjunction between a given inner reel element and a bonus symbol of the second feature game will not remain the same if the outer reels have more elements than the inner reels, so that for each successive passage of a second feature game symbol through the display, it may appear in associated with a different symbol of the inner reels.

When both sets of reels have been brought to rest, the awarding of a jackpot prize or one or more bonus feature games depends on a predetermined conjunction between the symbols now displayed on the inner reels and the pattern of overlying symbols of the second feature game outer reels.

It should be noted that the randomised rotation, selection of winning elements to appear on a pay line and any other parameters of the primary game, are generated by code drawn from data storage devices of each machine independent from that of a second feature game triggered by, and subsequently controlled from one of the linked machines. The only correlation therefore between these two aspects is the synchronization of the angular velocity and registration of elements of the two matrices within the display boundary. Indeed the bonus feature need not be initiated for every play of the primary game, but may be offered as an optional feature.

The set of inner reels and the symbols thereon are constant for any primary game played on the machine. However, the set of outer reels is selected from a plurality of sets of outer reels, which may be simulated for a given play of the primary game. Each set of the plurality of sets comprises a different configuration of bonus feature symbols and each set is associated with a different probability of conferring one or more bonus feature games. The probability of triggering one or more bonus feature games is greater than zero for all of the available plurality of sets.

The selection of a particular set of outer reels for any play of the primary game is basically random, but may be weighted in a number of ways depending on choices of play made by the player of a primary game. Thus for example, the weighting may be a function of the bet placed by a player or of the choice of pay line, or a combination of these.

The results of both the primary game and the bonus feature are displayed together at the conclusion of a spin of the game. The primary game will trigger on any symbols according to the game's pay table and any prize, bonus or free spins awarded. Following this, the result of the bonus feature is independently assessed through its pay table to determine if one or more bonus feature games should be awarded.

### Second Preferred Embodiment

In a second preferred embodiment of a second feature game to be played on a bank of linked gaming machines, a primary game is again played on a set of inner reels 240, with a bonus feature implemented by a set of outer reels 242 as described for the First Preferred Embodiment above. In this form of the invention however, the symbol containing elements of the inner set of reels are not necessarily defined by four sides or as simple division of the reels into a plurality of segments as depicted in FIG. 15, but may be made up of n-sided elements where n is an integer including the values 1, 3, 4 and 5 through 20.

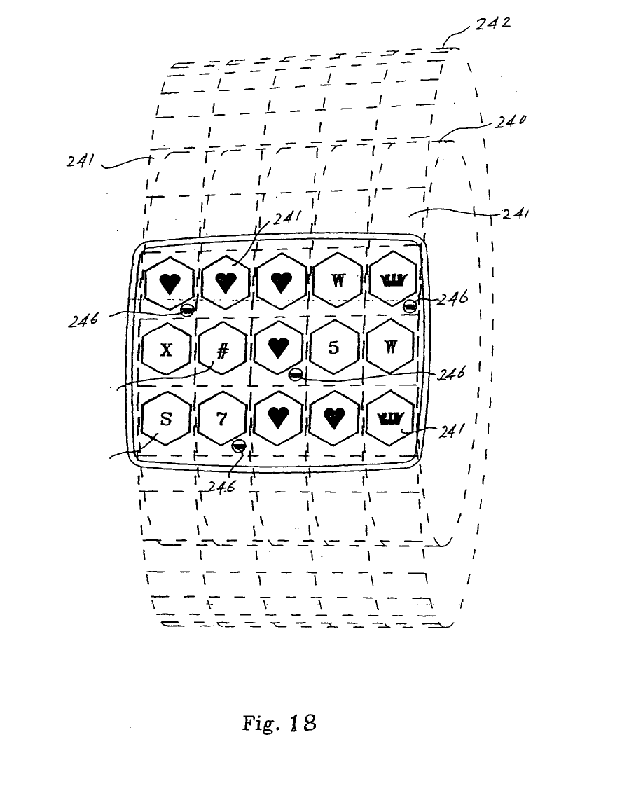

As for example, shown in FIG. 18, inner reels 240 now comprise a plurality of inner reel elements 241 delineated by hexagonal boundaries where n=6. When both inner reels 240 and bonus feature outer reels 242 are at rest, bonus symbols 243 carried on the bonus feature outer reels 242 appear adjacent the hexagonal boundary of a number of inner reel elements 241. As also shown by dashed lines in FIG. 18, the divisions between adjoining reels and adjoining elements may be notional, and not actually displayed.

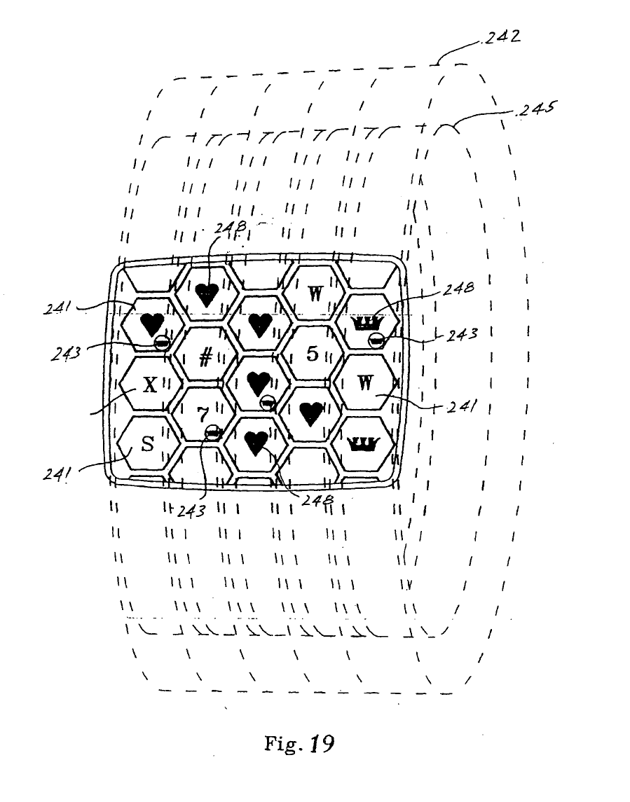

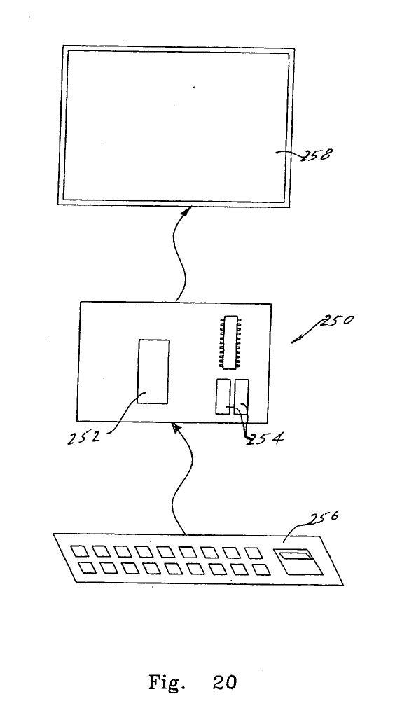

The n-sided inner reel elements 241 of each adjoining inner reel 240 in FIG. 18 are in vertical alignment, but in at least one preferred form for the special case of n=6, the hexagon elements may be nested when the reels come to rest as shown in FIG. 19. The inner reels 240 then overlap and during rotation, side portions of the hexagonal elements of adjoining reels will appear to overlap also. When at rest the notional divisions between elements 241 of adjoining inner reels 240, and bonus feature outer reels 242 are staggered so as to form the nested disposition of the hexagonal inner reel elements 241 and the corresponding bonus feature symbols.

In this embodiment the symbols 246 of the bonus feature will appear within the boundaries of the hexagonal elements 247 but so arranged as not to obscure the symbols 248 of the primary game. This may be achieved as indicated in FIG. 19, by suitable sizing and placement of both the primary game symbol and the bonus feature symbol.

Any of the above described embodiments may be implemented on any gaming machine or group of gaming machine provided with a control module. As shown in FIG. 20, a control module 250 is provided with a microprocessor 252 and working random access memory (RAM) 254. The program code driving any of the described embodiments may be introduced into the control module 250 by connection of a data storage device. The device may take any of a number of forms, such as read only memory (ROM), erasable read only memory (EPROM), Compact Flash Card, PCMCIA card and the like. Alternatively, control module 250 may incorporate a hard disc drive to which the code may be written via a suitable input device.

Control module 250 acts to implement appropriate elements of the program code according to inputs from a user keyboard 256 and outputs video imagery to at least a main display module 258. In the topology described above, in which any one or all the gaming machines may be provided with a secondary feature game software module, that module may be resident on control module 250 of FIG. 12, or alternatively may be resident on the logic unit of 47 FIGS. 9 to 11.

The above describes only some embodiments of the present invention and modifications, obvious to those skilled in the art, can be made thereto without departing from the scope and spirit of the present invention.

What is claimed is:

1. A topology for a bank of linked gaming machines; each gaming machine of said bank of linked gaming machines comprising a dual display gaming machine having a first display for display of a primary game and a second display; said second display located above said first display on each said gaming machine; each said dual display gaming machine further including at least a machine logic unit which controls said primary game and its display on said first display; each said dual display gaming machine further including a display and controller unit which controls what is displayed on said second display; a jackpot controller including computing and display means linked to said bank of gaming machines, the gaming machines arranged to display on said main display selected game features wherein randomized events are caused to award a prize if a predefined event occurs, the controller being characterized in that it is arranged to provide a second game feature; said topology comprising said bank of linked gaming machines in electronic communication with said jackpot controller whereby at least a first predefined portion of data associated with said second game feature is displayed on said main display of at least selected ones of said bank of linked gaming machines; and wherein at least a second predefined portion of data associated with said second game feature is displayed on said second display of at least said selected ones of said bank of gaming machines.

2. The topology of claim 1 wherein said first predetermined portion of data comprises animated graphics video data.

3. The topology of claim 1 wherein said second predetermined portion of data comprises data video.

4. The topology of claim 2 wherein said animated graphics video data comprises an animation of a horse race.

5. The topology of claim 3 wherein said data video comprises horse allocation data; eligible machine data and jackpot amount data.

6. The topology of claim 1 wherein said first predetermined portion of data is additionally displayed on an overhead display visible to players at each machine of said bank of gaming machines.

7. The topology of claim 1 wherein said second predetermined portion of data is additionally displayed on an overhead display visible to all players at machines forming said bank of gaming machines.

8. The topology of claim 1 wherein said jackpot controller includes a CPU, a memory device and input and output devices.

9. The topology of claim 1 wherein said first predetermined portion of data is supplied to a graphics video splitter; said graphics video splitter receiving a main game video signal from said machine logic unit; said graphics video splitter arranged to supply either said first predetermined portion of data or said main game video signal to said first display of at least said selected ones of said gaming machines.

10. A topology for a bank of linked gaming machines; each gaming machine of said bank of linked gaming machines having at least a first display for display of a primary game; each said linked gaming machine further including at least a machine logic unit which controls said primary game and its display on said at least a first display; and wherein at least one of said linked gaming machines is provided with a second feature game software module; said second feature game software module of any one of said gaming machines selecting and controlling a common second feature game; a selection of said linked gaming machines participating in said second feature game.

11. The topology of claim 10 wherein each machine in said bank of linked gaming machines is provided with a second display.

12. The topology of claim 11 wherein each said machine is provided with a display controller unit which controls imagery displayed on said second display.

13. The topology of claim 10 wherein said selection of said linked gaming machines participating in said second feature game includes all of said linked gaming machines.

14. The topology of claim 10 wherein said selection of said linked gaming machines participating in said second feature game comprises a subset of said linked gaming machines.

15. The topology of claim 10 wherein a jackpot triggering event on said any one of said linked gaming machines instigates selection by that machine of said common second feature game and said selection of said linked gaming machines participating in said second feature game.

16. The topology of claim 10 wherein said common second feature game is displayed on a main overhead display module; said main overhead display module visible to all players of said bank of linked gaming machines.

17. The topology of claim 10 wherein said second common feature game is displayed on said second display of each of said selection of linked gaming machines.

18. The topology of claim 10 wherein said second feature game software module is incorporated into software of said primary game; said primary game software and said second feature game software resident on a common memory device of said machine logic unit.

19. The topology of claim 10 wherein each gaming machine of said bank of gaming machines is provided with a link interface module linked to a communication link and a site or jackpot controller.

20. The topology of claim 10 wherein said topology further includes a main display controller; said main display controller caused to display said second feature game under initiation signal from said any one of said linked gaming machines.

21. A method for control of a second feature game; said second feature game provided to at least selected gaming machines of a bank of linked gaming machines; said method including the steps of:
(a) initiating a second feature game control sequence by one gaming machine of said linked gaming machine when a jackpot triggering event occurs on said one gaming machine,
(b) said one gaming machine acquiring state of play data from remaining said linked gaming machines over a communication link,
(c) said one gaming selecting at least a number of said remaining linked gaming machines as selected participating gaming machines in said second feature game.

22. The method of claim 21 wherein said state of play data includes current state of play on said selected participating gaming machines.

23. The method of claim 21 wherein said state of play data includes last amount bet.

24. The method of claim 21 wherein said method includes the further steps of said one gaming machine:
(a) selecting a second feature game,
(b) transmitting data relevant to said selected second feature game for display on second display modules of said selected participating gaming machines,
(c) preventing new main games commencing on said selected participating gaming machines,
(d) initiating display of said second feature game.

25. The method of claim 21 wherein said second feature game is caused to be displayed on an overhead display module; said overhead display module visible to all players of said linked gaming machines.

26. The method of claim 21 wherein said second feature game is caused to be displayed on said second display of said one machine and on said second display of each of said selected participating machines.
